(19) United States
(12) Patent Application Publication
(10) Pub. No.: US 2026/0004501 A1
(43) Pub. Date: Jan. 1, 2026

(54) MOTION GENERATION MODEL-BASED MOTION GENERATION METHOD AND APPARATUS, AND DEVICE

(71) Applicant: Tencent Technology (Shenzhen) Company Limited, Shenzhen (CN)

(72) Inventors: Yang WU, Shenzhen (CN); Zhenyu XIE, Shenzhen (CN); Zhongqian SUN, Shenzhen (CN); Wei YANG, Shenzhen (CN); Xiaodan LIANG, Shenzhen (CN)

(73) Assignee: Tencent Technology (Shenzhen) Company Limited, Shenzhen (CN)

(21) Appl. No.: 19/320,182

(22) Filed: Sep. 5, 2025

Related U.S. Application Data
(63) Continuation of application No. PCT/CN2024/097618, filed on Jun. 5, 2024.

(30) Foreign Application Priority Data
Aug. 3, 2023 (CN) 202310969504.3

(51) Int. Cl. G06T 13/40; G06T 5/60; G06T 5/70

(52) U.S. Cl. CPC G06T 13/40; G06T 5/60; G06T 5/70

(57) ABSTRACT

Motion generation model-based motion generation method, device, and storage medium relate to the field of artificial intelligence technologies. The method includes: obtaining a text containing motion information; generating a text feature of the text through a text encoder; generating an intermediate motion sequence in a feature space of a first dimension based on the text feature through a first diffusion model; and performing detail enhancement processing on the intermediate motion sequence in a feature space of a second dimension through a second diffusion model, to obtain an output motion sequence matching the text, the second dimension being greater than the first dimension. In this application, the intermediate motion sequence is preliminarily generated through the first diffusion model, and detail enhancement processing is performed on the intermediate motion sequence through the second diffusion model, thereby improving the richness of details in the output motion sequence.

### RELATED APPLICATION

This application is a continuation application of the International PCT Application No. PCT/CN2024/097618, filed with the China National Intellectual Property Administration, PRC on Jun. 5, 2024, which claims priority to Chinese Patent Application No. 202310969504.3, filed on Aug. 3, 2023, each of which is incorporated herein by reference in its entirety.

### FIELD OF THE TECHNOLOGY

This application relates to the field of artificial intelligence technologies, and in particular, to a motion generation model-based motion generation method and apparatus, and a device.

### BACKGROUND OF THE DISCLOSURE

Text-driven motion synthesis is a generative method for generating human motion sequences based on text content. The text content may cover a plurality of motion scenarios (such as walking, talking, and exercising).

### SUMMARY

Embodiments of this disclosure provide a motion generation model-based motion generation method and apparatus, and a device. The technical solution includes the following aspects.

According to an aspect of the embodiments of this disclosure, a motion generation model-based motion generation method is provided. The motion generation model includes a text encoder, a first diffusion model, and a second diffusion model. The method includes: obtaining a text containing motion information; generating a text feature of the text through the text encoder; generating an intermediate motion sequence in a feature space of a first dimension based on the text feature through the first diffusion model; and performing detail enhancement processing on the intermediate motion sequence in a feature space of a second dimension through the second diffusion model, to obtain an output motion sequence matching the text, the second dimension being greater than the first dimension.

According to an aspect of the embodiments of this disclosure, a method for training a motion generation model is provided. The motion generation model includes a text encoder, a first diffusion model, and a second diffusion model. The method includes: obtaining a training sample set of the motion generation model, the training sample set including at least one motion text pair, each motion text pair including a sample text and an original motion sequence that have a matching relationship; generating a text feature of the sample text through the text encoder; generating, in a feature space of a first dimension based on the text feature through the first diffusion model, a first motion sequence matching the sample text; generating, in a feature space of a second dimension based on the text feature through the second diffusion model, a second motion sequence matching the sample text, the second dimension being greater than the first dimension; and adjusting parameters of the first diffusion model based on the first motion sequence and the original motion sequence, and adjusting parameters of the second diffusion model based on the second motion sequence and the original motion sequence, to obtain a trained motion generation model.

According to an aspect of the embodiments of this disclosure, a motion generation model-based motion generation apparatus is provided. The motion generation model includes a text encoder, a first diffusion model, and a second diffusion model. The method includes: a text obtaining module, configured to obtain a text containing motion information; a text feature generation module, configured to generate a text feature of the text through the text encoder; an intermediate sequence generation module, configured to generate an intermediate motion sequence in a feature space of a first dimension based on the text feature through the first diffusion model; and an output sequence generation module, configured to perform detail enhancement processing on the intermediate motion sequence in a feature space of a second dimension through the second diffusion model, to obtain an output motion sequence matching the text, the second dimension being greater than the first dimension.

According to an aspect of the embodiments of this disclosure, an apparatus for training a motion generation model is provided. The motion generation model includes a text encoder, a first diffusion model, and a second diffusion model. The apparatus includes: a sample set obtaining module, configured to obtain a training sample set of the motion generation model, the training sample set including at least one motion text pair, each motion text pair including a sample text and an original motion sequence that have a matching relationship; a text feature generation module, configured to generate a text feature of the sample text through the text encoder; a first sequence generation module, configured to generate, in a feature space of a first dimension based on the text feature through the first diffusion model, a first motion sequence matching the sample text; a second sequence generation module, configured to generate, in a feature space of a second dimension based on the text feature through the second diffusion model, a second motion sequence matching the sample text, the second dimension being greater than the first dimension; and a parameter adjustment module, configured to adjust parameters of the first diffusion model based on the first motion sequence and the original motion sequence, and adjust parameters of the second diffusion model based on the second motion sequence and the original motion sequence, to obtain a trained motion generation model.

According to an aspect of the embodiments of this disclosure, a computer device is provided. The computer device includes a processor and a memory. The memory has a computer program stored therein, the computer program being loaded and executed by the processor to implement the foregoing motion generation model-based motion generation method or method for training a motion generation model.

According to an aspect of the embodiments of this disclosure, a computer-readable storage medium (e.g., non transitory computer-readable storage medium) is provided. The computer-readable storage medium has a computer program stored therein, the computer program being loaded and executed by a processor to implement the foregoing motion generation model-based motion generation method or method for training a motion generation model.

According to an aspect of the embodiments of this disclosure, a computer program product is provided. The computer program product includes a computer program, the computer program being loaded and executed by a processor to implement the foregoing motion generation model-based motion generation method or method for training a motion generation model.

The technical solution provided in the embodiments of this disclosure can bring the following beneficial effects: The first diffusion model can process a feature in the feature space of the first dimension, the second diffusion model can process a feature in the feature space of the second dimension, and the second dimension is greater than the first dimension, so that the second diffusion model can focus more on a fine-grained feature. Therefore, the intermediate motion sequence is generated in the feature space of the first dimension through the first diffusion model, and modeling and diffusion is preliminarily performed on the text in the feature space of a low dimension. Since the motion sequence obtained through diffusion in the feature space of the low dimension lacks rich details, detail enhancement processing is further performed on the intermediate motion sequence in the feature space of the second dimension through the second diffusion model, to obtain an output motion sequence. Since the motion sequence is refined in the feature space of a high dimension, the output motion sequence has richer details and more closely matches the text. Compared with the related art in which a text modeling and diffusion process is performed only in the feature space of the low dimension, resulting in insufficient details of the generated motion sequence, the technical solution provided in this application enhances a detail feature in the output motion sequence in the feature space of the high dimension, thereby improving the richness of details in the output motion sequence.

### BRIEF DESCRIPTION OF THE DRAWINGS

FIG. 1 is a schematic diagram of an implementation environment according to an embodiment of this application.

FIG. 2 is a flowchart of a motion generation model-based motion generation method according to an embodiment of this application.

FIG. 3 is a schematic diagram of comparison between a motion sequence reconstruction effect and a real motion sequence according to an embodiment of this application.

FIG. 4 is a schematic structural diagram of a motion generation model according to an embodiment of this application.

FIG. 5 is a flowchart of another motion generation model-based motion generation method according to an embodiment of this application.

FIG. 6 is a schematic diagram of a motion sequence according to an embodiment of this application.

FIG. 7 is a schematic diagram of comparison between generation effects of a motion sequence generation method according to an embodiment of this application.

FIG. 8 is a flowchart of a method for training a motion generation model according to an embodiment of this application.

FIG. 9 is an algorithm flowchart of a use process of a motion generation model according to an embodiment of this application.

FIG. 10 is a block diagram of a motion generation model-based motion generation apparatus according to an embodiment of this application.

FIG. 11 is a block diagram of an apparatus for training a motion generation model according to an embodiment of this application.

FIG. 12 is a structural block diagram of a computer device according to an embodiment of this application.

### DESCRIPTION OF EMBODIMENTS

To make objectives, technical solutions, and advantages of this application clearer, the following further describes implementations of this application in detail with reference to the accompanying drawings.

Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, artificial intelligence is a comprehensive technology in computer science. This technology attempts to understand the essence of intelligence and produce a new intelligent machine that can react in a manner similar to human intelligence. Artificial intelligence is to study the design principles and implementation methods of various intelligent machines, so that the machines can perceive, infer, and make decisions.

The artificial intelligence technology is a comprehensive subject, relating to a wide range of fields, and involving both hardware and software techniques. Basic artificial intelligence technologies generally comprise technologies such as a sensor, a dedicated artificial intelligence chip, cloud computing, distributed storage, a big data processing technology, an operating/interaction system, and electromechanical integration. An artificial intelligence software technology mainly includes fields such as a computer vision technology, a speech processing technology, a natural language processing technology, and machine learning/deep learning.

Machine learning (ML) is a multi-field interdiscipline, and relates to a plurality of disciplines such as the probability theory, statistics, the approximation theory, convex analysis, and the algorithm complexity theory. The machine learning specializes in studying how a computer simulates or implements a human learning behavior to acquire new knowledge or skills, and reorganize an existing knowledge structure, to keep improving performance of the computer. The machine learning is the core of artificial intelligence, is a basic way to make the computer intelligent, and is applied to various fields of the artificial intelligence. The machine learning and deep learning generally include technologies such as an artificial neural network, a belief network, reinforcement learning, transfer learning, inductive learning, and learning from demonstrations.

With the research and progress of the artificial intelligence technology, the artificial intelligence technology is studied and applied in a plurality of fields such as a common smart home, a smart wearable device, a virtual assistant, a smart speaker, smart marketing, unmanned driving, automatic driving, an unmanned aerial vehicle, a robot, smart medical care, and smart customer service. It is believed that with the development of technologies, the artificial intelligence technology will be applied to more fields, and play an increasingly important role.

The technical solution of this application mainly relates to a machine learning technology in the artificial intelligence technology, and mainly relates to a training and using process of a motion generation model.

In the related art, in a text-driven motion synthesis scenario, an auto-encoder (AE) is first used to learn a text feature of a text, and then a variational auto-encoder (VAE) is used to transform a feature distribution of the text to a normal distribution in a feature space of a low dimension, thereby performing a modeling and diffusion process in the feature space and generating a motion sequence corresponding to the text feature. However, due to a limited expression capability of the feature space of the low dimension, a human motion sequence generated in the method often lacks rich details.

Based on this, this application provides a motion generation model-based motion generation method, and for a detailed process, refer to descriptions of the following embodiments.

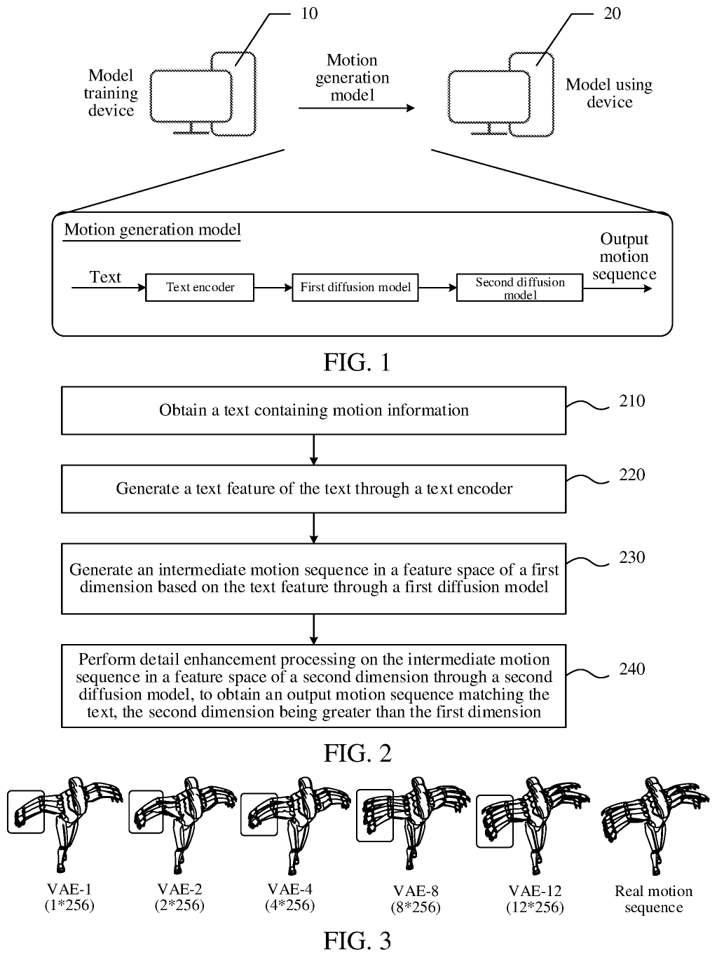

FIG. 1 is a schematic diagram of an implementation environment according to an embodiment of this application. The implementation environment may be a training and using system of a motion generation model. The implementation environment may include: a model training device 10 and a model using device 20.

The model training device 10 may be an electronic device such as a mobile phone, a tablet computer, a laptop computer, a desktop computer, a smart television, a multimedia playback device, an in-vehicle terminal, a server, an intelligent robot, or some other electronic devices with strong computing power. The model training device 10 is configured to train the motion generation model.

In this embodiment of this application, the motion generation model is a machine learning model obtained based on a method for training the motion generation model, and is configured to generate, based on a text containing motion information, an output motion sequence matching the text. The model training device 10 may train the motion generation model in a machine learning manner, to enable the motion generation model to have a capability of generating, based on the text, the output motion sequence matching the text. For a specific method for training the model, refer to the following embodiments.

The motion generation model includes a text encoder, a first diffusion model, and a second diffusion model. The text encoder is configured to encode the text to generate a text feature of the text; the first diffusion model is configured to generate an intermediate motion sequence in a feature space of a low dimension; and the second diffusion model is configured to perform detail enhancement processing on the intermediate motion sequence in a feature space of a high dimension, to obtain the output motion sequence matching the text. The low dimension and the high dimension herein are relative. In other words, the dimension of the feature space in which the second diffusion model performs processing is higher than the dimension of the feature space in which the first diffusion model performs processing. For example, the first diffusion model is configured to perform processing in a feature space of a first dimension, the second diffusion model is configured to perform processing in a feature space of a second dimension, and the second dimension is greater than the first dimension.

A dimension of a feature space refers to a quantity of elements included in a feature in the feature space. For example, if the feature in the feature space is a feature vector, the dimension of the feature space refers to a quantity of feature values included in the feature vector in the feature space, namely, a length of the feature vector, and feature values on different dimensions represent characteristics on different attributes. For example, if the first dimension is 2*256, a dimension of a feature in the feature space of the first dimension is 2*256. Exemplarily, “2” may represent two groups, channels, or sets of features (e.g., two categories of attributes or two directions of measurement), and “256” represents the number of feature values contained in each group or channel. Accordingly, the feature vector in this case comprises a total of 512 elements (2×256), with each group capturing 256 distinct feature values that describe the object across different aspects. If the second dimension is 8*256 (e.g., 8 channels or groups), a dimension of a feature in the feature space of the second dimension is 8*256. The second dimension is greater than the first dimension.

The first diffusion model and the second diffusion model are a type of generative models in the field of artificial intelligence. This type of generative models gradually restores a real data distribution from a Gaussian noise distribution by using a neural network through a plurality of rounds of iterative learning. A diffusion model mainly includes two diffusion processes, namely, a forward diffusion process and a reverse diffusion process. In the forward diffusion process, Gaussian noise is gradually added to a text, to obtain a series of noise-added texts in different noise strengths, and the noise-added texts are configured for learning of a diffusion network. In the reverse diffusion process, the noise-added texts are gradually denoised by using a trained diffusion network, to restore a motion sequence from the Gaussian noise.

The first diffusion model and the second diffusion model both function to generate motion sequences through forward diffusion and reverse diffusion. The difference is that the dimension of the feature space in which the first diffusion model performs processing is lower than the dimension of the feature space in which the second diffusion model performs processing. The first diffusion model can process a coarse-grained feature during the diffusion, while the second diffusion model can mine a fine-grained feature during the diffusion. Therefore, after a coarse-grained motion sequence is generated through the first diffusion model, the coarse-grained motion sequence may be refined through the second diffusion model, to generate a motion sequence with richer details. The first diffusion model may be referred to as a “basic diffusion model”, and the second diffusion model may be referred to as an “advanced diffusion model”.

Therefore, in this embodiment of this application, the text is inputted into the motion generation model, the text feature of the text is first generated through the text encoder, then the intermediate motion sequence is generated in the feature space of the low dimension based on the text feature through the first diffusion model, and finally, detail enhancement processing is performed on the intermediate motion sequence in the feature space of the high dimension through the second diffusion model, to obtain the output motion sequence matching the text.

A trained motion generation model may be deployed in the model using device 20 for use. The model training device 20 may be a terminal device such as a mobile phone, a tablet computer, a laptop computer, a desktop computer, a smart television, a multimedia playback device, an in-vehicle terminal, or an intelligent robot, or may be a server. When the output motion sequence matching the text needs to be generated based on the text, the model using device 20 may implement the foregoing function through the trained motion generation model.

The model training device 10 and the model using device 20 may be two independent devices or may be the same device. If the model training device 10 and the model using device 20 are the same device, the model training device 10 may be deployed in the model using device 20.

In this embodiment of this application, operations may be performed by a computer device. The computer device is an electronic device with data calculation, processing, and storage functions. The computer device may be a terminal device such as a mobile phone, a tablet computer, a laptop computer, a desktop computer, a smart television, a multimedia playback device, an in-vehicle terminal, or an intelligent robot, or may be a server. The server may be an independent physical server, or may be a server cluster including a plurality of physical servers or a distributed system, or may further be a cloud server that provides a cloud computing service. The computer device may be the model training device 10 in FIG. 1, or may be the model using device 20.

FIG. 2 is a flowchart of a motion generation model-based motion generation method according to an embodiment of this application. The motion generation model includes a text encoder, a first diffusion model, and a second diffusion model. Operations of the method may be performed by a computer device. The method may include at least one of the following operations 210 to 240.

Operation 210: Obtain a text containing motion information.

The motion information refers to a text segment including a motion description. The motion description is a text description for a motion feature of a human body part, and may cover a plurality of motion scenarios in daily life. Exemplarily, the motion information may be a text description for a motion feature of a single human body part. For example, the motion information may be a text description for a motion feature of legs of a human, such as walking, jogging, kicking, or stepping backward; or may be a text description for a motion feature of hands of a human, such as raising hands, waving, clapping, or clenching a fist; or may be a text description for a motion feature of the head of a human, such as looking up, looking down, talking, or smiling; and so on. Exemplarily, the motion information may alternatively be a text description for an overall motion feature of a plurality of body parts of a human, such as swinging arms while running, bending over to pick up objects, climbing stairs, or dancing.

The human mentioned herein may be a real human or a virtual human. If the human is a virtual human, the human may not be limited to a human form and may include an animal form or any virtual form created independently.

The text includes the motion information. The motion information is configured for describing a motion. The motion information refers to a text segment configured for describing a motion in the text. Exemplarily, the text may be “someone waves the right hand”, where “waves the right hand” is the motion information.

Operation 220: Generate a text feature of the text through the text encoder.

The text encoder is configured to encode the text, to generate the text feature of the text. Exemplarily, the text encoder may be a clip text encoder.

The computer device inputs the text to the text encoder. The text encoder encodes the text, and outputs the text feature. The text feature represents the semantics of the text. If the text includes motion information configured for describing a motion, the text feature includes a feature representing the motion.

In this embodiment of this application, the text feature generated through the text encoder may be a text feature of a first dimension, and the first dimension is a dimension of a feature space in which the first diffusion model performs processing.

Operation 230: Generate an intermediate motion sequence in the feature space of the first dimension based on the text feature through the first diffusion model.

The intermediate motion sequence includes at least one motion. Since the intermediate motion sequence is obtained through diffusion of the text feature, the motion in the intermediate motion sequence matches a motion represented by the text feature. The motion represented by the text feature is the motion described in the text. Therefore, the motion in the intermediate motion sequence matches the motion described in the text. However, since the first diffusion model performs processing only in a feature space of a relatively low dimension, and it is difficult to mine a fine-grained feature, the intermediate motion sequence generated by the first diffusion model has relatively low detail richness, that is, the matching degree between the intermediate motion sequence and the text is relatively low. The relatively herein refers to comparison with an output motion sequence generated by the second diffusion model.

In some embodiments, the first diffusion model includes a first variational auto-encoder and a first denoiser. The first variational auto-encoder includes a first encoder and a first decoder.

The first variational auto-encoder is any variational auto-encoder, including the first encoder and the first decoder. The first variational auto-encoder is configured to add Gaussian noise to an encoded feature, and decode a noise-added feature.

In this embodiment of this application, the first diffusion model transforms the text feature of the text to a latent space distribution in the feature space of the first dimension, and then performs modeling and diffusion in the feature space, to reconstruct the latent space distribution in the feature space into the intermediate motion sequence. The Gaussian noise added during encoding and decoding of the first variational auto-encoder is noise of the first dimension. The first encoder is configured to transform the text feature to the latent space distribution in the feature space of the first dimension, and the first decoder is configured to reconstruct the latent space distribution of the first dimension into the intermediate motion sequence.

Different variational auto-encoders may correspond to feature spaces of different dimensions. In the feature spaces of different dimensions, motion sequences reconstructed by the variational auto-encoders are different. Generally, a motion sequence reconstruction effect of a variational auto-encoder corresponding to a feature space of a high dimension is better than a motion sequence reconstruction effect of a variational auto-encoder corresponding to a feature space of a low dimension.

FIG. 3 is a schematic diagram of comparison between motion sequence reconstruction effects of different variational auto-encoders (VAEs) and a real motion sequence in feature spaces of different dimensions according to an embodiment of this application. It may be observed from FIG. 3 that when a dimension of a feature space is low, for example, when a feature dimension is 1*256, 2*256, or 4*256, a motion sequence reconstruction result of a variational auto-encoder lacks details of a hand motion. For details, refer to hand motions in annotated boxes of VAE-1, VAE-2, and VAE-4. When a dimension of a feature space is high, for example, when a feature dimension is 8*256, or 12*256, a motion sequence reconstruction result of a variational auto-encoder includes rich details of a hand motion. For details, refer to hand motions in annotated boxes of VAE-8 and VAE-12. Compared with details of a hand motion in the real motion sequence, apparently, hand motion sequences in VAE-8 and VAE-12 are closer to the details of the hand motion in the real motion sequence. It can be seen that motion sequence reconstruction effects of VAE-8 and VAE-12 are better than motion sequence reconstruction effects of VAE-1, VAE-2, and VAE-4.

Operation 230 includes at least one sub-operation of operations 231 and 232 (not shown in FIG. 2).

Operation 231: Generate a random motion feature of random noise through the first encoder, a dimension of the random motion feature being the first dimension.

The first encoder is an encoder included in the first variational auto-encoder.

The random motion feature refers to a noise motion feature that is randomly generated and represents feature information of a random motion sequence. The random motion feature may be understood as a feature of random noise, while the random noise can represent a random motion sequence. The random motion feature may be generated from a random number (or may be referred to as a random seed), for example, the random motion feature is formed by a plurality of random numbers. Different random numbers correspond to different random motion features, and the random number refers to any number. The random motion features corresponding to different random numbers have different motion characteristics, which may be motion characteristics with different motion styles, for example, an exaggerated motion in an animation style, a subtle motion in a traditional style, and a casual motion in a leisure style.

In some embodiments, the random motion feature is directly randomly generated through the first encoder, rather than being obtained by first randomly generating random noise and then encoding the random noise. Alternatively, random noise may be first randomly generated, and then the random noise is encoded through the first encoder, to obtain the random motion feature of the first dimension.

Operation 232: Generate the intermediate motion sequence based on the random motion feature and the text feature through the first denoiser and the first decoder.

In some embodiments, first noise of the first dimension is added to the random motion feature, to obtain a noise-added random motion feature; the noise-added random motion feature is denoised based on the text feature through the first denoiser, to obtain a denoised random motion feature of the first dimension; and the denoised random motion feature is decoded through the first decoder, to obtain the intermediate motion sequence.

The first diffusion model includes a forward diffusion process and a reverse diffusion process. Noise is added to the random motion feature gradually in the forward diffusion process of the first diffusion model, and the random motion feature gradually loses feature information thereof. After T times of noise addition, the random motion feature becomes a latent space distribution without any motion feature, where T is a positive integer. Further, the latent space distribution is denoised and decoded in the reverse diffusion process of the first diffusion model, to reconstruct the intermediate motion sequence. The reverse diffusion process of the first diffusion model is a processing process of the first denoiser and the first decoder. The latent space distribution refers to a probability distribution in a latent space, which is a continuous vector space, and a feature in the latent space is an underlying and abstract representation of data.

The first denoiser is any denoiser, and is configured to gradually denoise the noise-added random motion feature based on a constraint condition (namely, the text feature) in the feature space of the first dimension, so that motion features controlled and constrained by the text feature are gradually revealed. After T times of denoising, the denoised random motion feature becomes a motion feature matching the text.

The first decoder is a decoder included in the first variational auto-encoder, and is configured to reconstruct output data of the first denoiser into the intermediate motion sequence. The intermediate motion sequence is output data of the first diffusion model, and represents an intermediate denoising result obtained through gradual denoising by the first diffusion model.

Since the denoised random motion feature is obtained under the constraint of the text feature of the text, the denoised random motion feature matches the semantics of the text. Since the intermediate motion sequence is decoded from the denoised random motion feature, the intermediate motion sequence matches the semantics of the text. The semantics of the text refer to semantic information corresponding to the text, and represent a semantic feature expressed by the text, including the semantics of the motion information. That the intermediate motion sequence matches the semantics of the text means that the intermediate motion sequence matches the semantics of the motion information of the text. The intermediate motion sequence may provide a preliminary overview of the motion information included in the text.

In this embodiment of this application, the intermediate motion sequence is preliminarily reconstructed in the feature space of the low dimension based on the random motion feature of the first dimension and the text feature of the first dimension through the first diffusion model. This provides a basis for a subsequent diffusion process in which detail enhancement processing is performed on the intermediate motion sequence in the feature space of the high dimension, and is conducive to improving the convenience and speed of the motion sequence reconstruction process. In addition, through the forward diffusion process and the reverse diffusion process of the first diffusion model, the random motion feature is denoised under the constraint condition of the text feature. This enables the reconstructed intermediate motion sequence to match the text as closely as possible, thereby improving the accuracy of the motion sequence reconstruction process.

Operation 240: Perform detail enhancement processing on the intermediate motion sequence in a feature space of a second dimension through the second diffusion model, to obtain an output motion sequence matching the text, the second dimension being greater than the first dimension.

The intermediate motion sequence is input data of the second diffusion model, and the second diffusion model is configured to further perform enhancement processing on the intermediate motion sequence obtained by the first diffusion model, to obtain the output motion sequence that matches the text and has richer details.

The detail enhancement processing means adjusting a motion in the intermediate motion sequence, to improve the richness of details of the motion in the intermediate motion sequence. In this embodiment of this application, performing detail enhancement processing by using the second diffusion model means adding noise to the intermediate motion sequence through the second diffusion model and gradually removing the noise to restore the output motion sequence with richer details.

That the output motion sequence matches the text means that a motion in the output motion sequence is consistent with a motion described in the text. For example, if the motion described in the text is a running motion, at least one motion in the output motion sequence forms the running motion.

In some embodiments, the second diffusion model includes a second variational auto-encoder and at least two second denoisers. The second variational auto-encoder includes a second encoder and a second decoder.

The second variational auto-encoder is any variational auto-encoder, including the second encoder and the second decoder. The second variational auto-encoder is configured to add Gaussian noise to an encoded feature, and decode a noise-added feature.

In this embodiment of this application, the second diffusion model transforms the intermediate motion sequence to a latent space distribution in the feature space of the second dimension, and then performs a modeling and diffusion process in the feature space, to further reconstruct the latent space distribution in the feature space into the output motion sequence matching the text. The Gaussian noise added during encoding and decoding of the second variational auto-encoder is noise of the second dimension. The second encoder is configured to transform the intermediate motion sequence to the latent space distribution in the feature space of the second dimension, and the second decoder is configured to reconstruct the latent space distribution of the second dimension into the output motion sequence.

Since the second dimension is greater than the first dimension, compared with the first diffusion model, the feature space corresponding to the second diffusion model is the feature space of the high dimension, the feature space corresponding to the first diffusion model is the feature space of the low dimension, and a motion sequence reconstruction effect of the second variational auto-encoder in the second diffusion model is better than a motion sequence reconstruction effect of the variational auto-encoder in the first diffusion model.

The output data of the first diffusion model is used as the input data of the second diffusion model, and by using the second diffusion model, detail enhancement processing is performed on the intermediate motion sequence outputted by the first diffusion model, so that the obtained output motion sequence more closely matches the text in details, thereby improving the richness of details in the motion sequence. Therefore, the output motion sequence more closely matches the text than the intermediate motion sequence, and details of the output motion sequence are richer than details of the intermediate motion sequence.

Operation 240 includes at least one sub-operation of operations 241 and 242 (not shown in FIG. 2).

Operation 241: Generate an intermediate motion feature of the intermediate motion sequence through the second encoder, a dimension of the intermediate motion feature being the second dimension.

The second encoder is an encoder included in the second variational auto-encoder, and is configured to transform the intermediate motion sequence to the latent space distribution in the feature space of the second dimension.

The intermediate motion feature is a latent space distribution of the intermediate motion sequence generated by the second encoder, and represents a feature distribution of the intermediate motion sequence in the feature space of the second dimension.

In some embodiments, the second encoder encodes the intermediate motion sequence, to obtain the intermediate motion feature.

Operation 242: Generate, based on the intermediate motion feature through the at least two second denoisers and the second decoder, the output motion sequence matching the text.

In some embodiments, second noise of the second dimension is added to the intermediate motion feature, to obtain a noise-added intermediate motion feature; the noise-added intermediate motion feature is denoised through the at least two second denoisers sequentially, to obtain a denoised intermediate motion feature of the second dimension; and the denoised intermediate motion feature is decoded through the second decoder, to obtain the output motion sequence matching the text.

The intermediate motion sequence is used as the input data of the second diffusion model. The second diffusion model includes a forward diffusion process and a reverse diffusion process. Noise is added to the intermediate motion feature gradually in the forward diffusion process of the second diffusion model, and the intermediate motion feature gradually loses feature information thereof. After T^{h} times of noise addition, the intermediate motion feature becomes a latent space distribution without any motion feature, where T^{h} is an integer greater than or equal to 2. Further, the latent space distribution is denoised and decoded in the reverse diffusion process of the second diffusion model, to reconstruct the output motion sequence. The reverse diffusion process of the second diffusion model is a processing process of the at least two second denoisers and the second decoder.

In some embodiments, that the noise-added intermediate motion feature is denoised through the at least two second denoisers sequentially, to obtain a denoised intermediate motion feature of the second dimension includes: The noise-added intermediate motion feature is denoised based on the text feature of the text through the at least two second denoisers sequentially, to obtain the denoised intermediate motion feature of the second dimension.

The at least two second denoisers are any two denoisers, and are configured to gradually denoise the noise-added intermediate motion feature based on a constraint condition (namely, the text feature) in the feature space of the second dimension, so that motion features controlled and constrained by the text feature are gradually revealed. After T^{h} times of denoising, the denoised intermediate motion feature is further transformed to the motion feature matching the text.

The second decoder is a decoder included in the second variational auto-encoder, and is configured to reconstruct output data of the at least two second denoisers into the output motion sequence matching the text. The output motion sequence is output data of the second diffusion model, which is configured for representing a motion sequence matching the text, and can restore motion details described in the text.

In this embodiment of this application, through the forward diffusion process and the reverse diffusion process of the second diffusion model, the intermediate motion sequence outputted by the first diffusion model is denoised under the constraint condition of the text feature. This enhances a detail feature in the reconstructed output motion sequence, so that the obtained output motion sequence more closely matches the text in details, thereby improving the richness of details in the motion sequence.

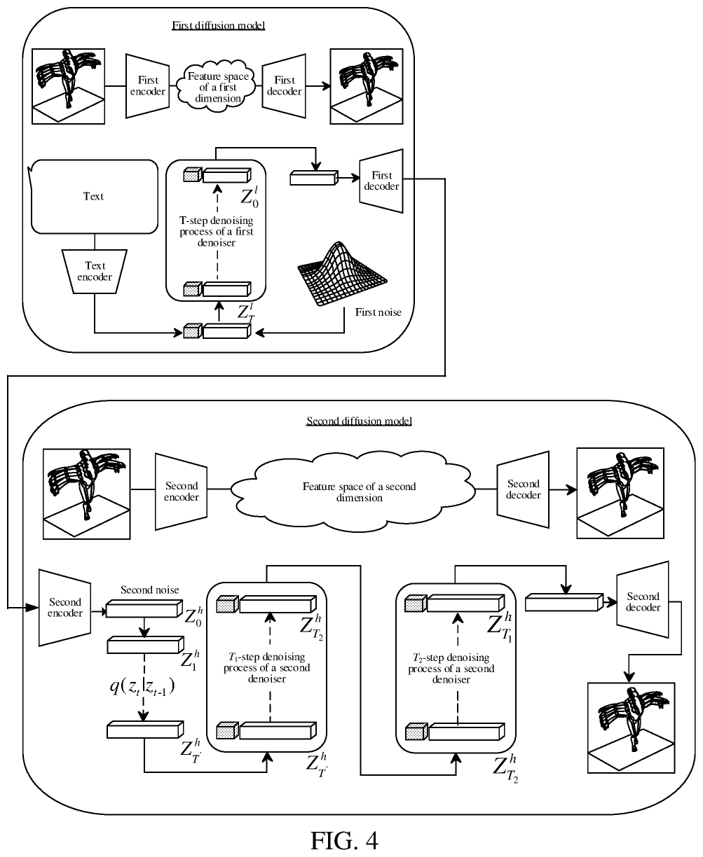

FIG. 4 shows a schematic structural diagram of a motion generation model. Implementation procedures of the first diffusion model and the second diffusion model are roughly the same: An encoder transforms inputted data to a noise distribution in a feature space of a variational auto-encoder, noise is added to the noise distribution, then the noise-added noise distribution is transformed to a denoised feature distribution in the feature space, and finally, a decoder reconstructs the denoised feature distribution into a motion sequence. A difference between network frameworks of the two diffusion models is that the dimension of the feature space of the first diffusion model is lower than that of the feature space of the second diffusion model, and in the first diffusion model, the noise-added random motion feature is denoised by one first denoiser, while in the second diffusion model, the noise-added intermediate motion feature is denoised by at least two second denoisers (two second denoisers are used as an example in FIG. 4).

Gray blocks displayed in the first denoiser and the second denoiser in FIG. 4 refer to text features of the text. The denoisers denoise noise-added motion features based on the text features, to obtain denoised motion features. A quantity of denoising operations during denoising is related to a dimension of the added noise. For example, if a dimension of the first noise is lower than a dimension of the second noise, a quantity of denoising operations of the first denoiser in the first diffusion model is less than a sum of quantities of denoising operations of the at least two second denoisers in the second diffusion model.

FIG. 4 also shows a connection relationship between the first diffusion model and the second diffusion model. The output data of the first diffusion model is used as the input data of the second diffusion model, and the second diffusion model further performs detail enhancement processing on the intermediate motion sequence outputted by the first diffusion model, to obtain the output motion sequence more closely matching the motion information in the text. The output motion sequence can better restore motion details described in the text.

In the technical solution provided in the embodiments of this disclosure, the first diffusion model can process a feature in the feature space of the first dimension, the second diffusion model can process a feature in the feature space of the second dimension, and the second dimension is greater than the first dimension, so that the second diffusion model can focus more on a fine-grained feature. Therefore, the intermediate motion sequence is generated in the feature space of the first dimension through the first diffusion model, and modeling and diffusion is preliminarily performed on the text in the feature space of a low dimension. Since the motion sequence obtained through diffusion in the feature space of the low dimension lacks rich details, detail enhancement processing is further performed on the intermediate motion sequence in the feature space of the second dimension through the second diffusion model, to obtain an output motion sequence. Since the motion sequence is refined in the feature space of a high dimension, the output motion sequence has richer details and more closely matches the text. Compared with the related art in which a text modeling and diffusion process is performed only in the feature space of the low dimension, resulting in insufficient details of the generated motion sequence, the technical solution provided in this application enhances a detail feature in the output motion sequence in the feature space of the high dimension, thereby improving the richness of details in the output motion sequence.

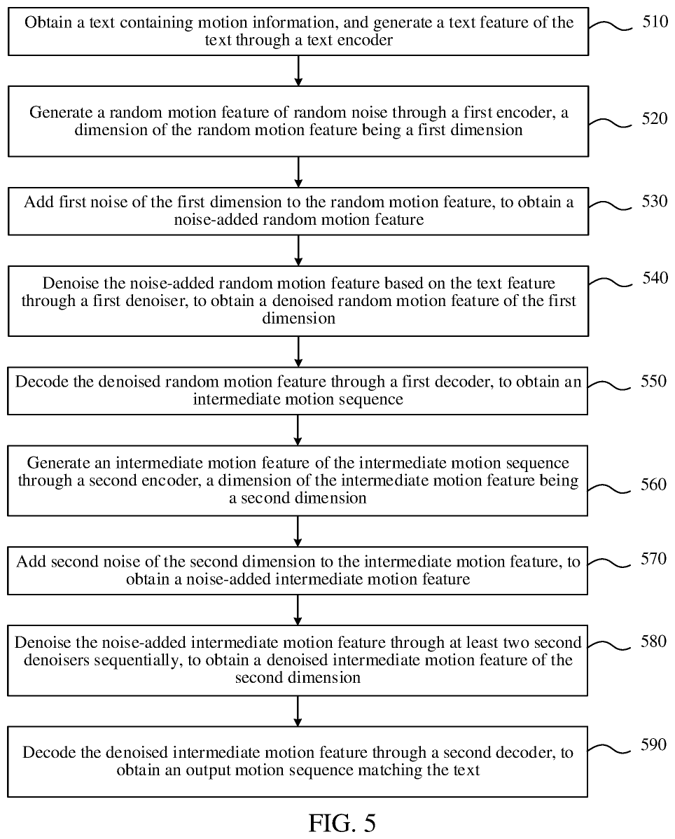

FIG. 5 is a flowchart of another motion generation model-based motion generation method according to an embodiment of this application. Operations of the method may be performed by a computer device. The method may include at least one of the following operations 510 to 590.

Operation 510: Obtain a text containing motion information, and generate a text feature of the text through a text encoder.

Operation 520: Generate a random motion feature of random noise through a first encoder, a dimension of the random motion feature being a first dimension.

For related content of the foregoing operation 510 and operation 520, refer to the foregoing embodiments, and details are not described herein again.

Operation 530: Add first noise of the first dimension to the random motion feature, to obtain a noise-added random motion feature.

The first noise refers to Gaussian noise of the first dimension, and the random motion feature is a feature distribution of the first dimension. In some embodiments, the first noise may be gradually added to the random motion feature in T times, or the first noise may be added to the random motion feature all at once, to obtain the noise-added random motion feature. The noise-added random motion feature is a noise distribution without a motion feature, and a dimension of the noise-added random motion feature is also the first dimension.

Operation 540: Denoise the noise-added random motion feature based on the text feature through a first denoiser, to obtain a denoised random motion feature of the first dimension.

The noise-added random motion feature is gradually denoised based on the text feature through the first denoiser, and the denoised random motion feature of the first dimension is obtained after T times of denoising. The denoised random motion feature is a motion feature matching semantic information of the text feature, and includes a motion feature corresponding to the motion information.

In some embodiments, there may be one or more first denoisers. In this embodiment of this application, to improve the operation efficiency of a first diffusion model, a quantity of first denoisers is set to 1, as shown in a single denoiser network framework in FIG. 4.

Operation 550: Decode the denoised random motion feature through a first decoder, to obtain an intermediate motion sequence.

The denoised random motion feature is decoded through the first decoder, to reconstruct the denoised random motion feature into the intermediate motion sequence.

In this embodiment of this application, the noise-added random motion feature is denoised through a modeling and diffusion process of the random motion feature in the feature space of the first dimension, to preliminarily obtain the intermediate motion sequence. Due to the simple distribution of a feature space of a low dimension, transformation from a noise distribution to a feature distribution is easily implemented, resulting in an efficient processing process.

Operation 560: Generate an intermediate motion feature of the intermediate motion sequence through a second encoder, a dimension of the intermediate motion feature being a second dimension.

For related content of the foregoing operation 560, refer to the foregoing embodiments, and details are not described herein again.

Operation 570: Add second noise of the second dimension to the intermediate motion feature, to obtain a noise-added intermediate motion feature.

The second noise refers to Gaussian noise of the second dimension, and the intermediate motion feature is a feature distribution of the second dimension. In some embodiments, the second noise may be gradually added to the intermediate motion feature in T^{h} times, or the second noise may be added to the intermediate motion feature all at once, to obtain the noise-added intermediate motion feature. The noise-added intermediate motion feature is a noise distribution without a motion feature, and a dimension of the noise-added intermediate motion feature is also the second dimension.

Operation 580: Denoise the noise-added intermediate motion feature through at least two second denoisers sequentially, to obtain a denoised intermediate motion feature of the second dimension.

In some embodiments, the noise-added intermediate motion feature is gradually denoised based on the text feature through the at least two second denoisers, and the denoised intermediate motion feature of the second dimension is obtained after T^{h} times of denoising. The denoised intermediate motion feature is a motion feature further matching a detail feature of the motion information based on matching semantic information of the text feature.

In some embodiments, a quantity of second denoisers is N, and N is an integer greater than or equal to 2.

In this way, the noise-added intermediate motion feature is denoised for Tᵢ times by an i^{th} second denoiser, and the noise-added intermediate motion feature is denoised for T^{h} times in total by N second denoisers, where Tᵢ is a positive integer. Exemplarily, if the noise-added intermediate motion feature is denoised for T₁ times by the first second denoiser, and the noise-added intermediate motion feature is denoised for T₂ times by the second second denoiser, T^{h}=T₁+T₂+ . . . T_{N}.

In this embodiment of this application, to implement coordination of the operation efficiency and generation effect, and to avoid the reduction of the operation efficiency due to an excessive quantity of second denoisers, the quantity of second denoisers is set to 2, as shown in a multi-denoiser network framework in FIG. 4. If the noise-added intermediate motion feature is denoised for T₁ times by the first second denoiser, and the noise-added intermediate motion feature is denoised for T₂ times by the second second denoiser, T^{h}=T₁+T₂.

Operation 580 includes at least one sub-operation of operations 581 to 583 (not shown in the figure).

Operation 581: Denoise the noise-added intermediate motion feature for Tᵢ times through an i^{th} second denoiser, to obtain an i^{th} denoised intermediate motion feature, i being a positive integer less than or equal to N, an initial value of i being 1, and Tᵢ being a positive integer.

Operation 582: If i is less than N, increment i by 1, and repeat operation 581.

If i is less than N, it indicates that denoising of the noise-added intermediate motion feature is not completed, and the i^{th} denoised intermediate motion feature needs to be continuously denoised. i is incremented by 1, and the i^{th} denoised intermediate motion feature is denoised for Tᵢ₊₁ times through an (i+1)^{th} second denoiser, to obtain an (i+1)^{th} denoised intermediate motion feature.

Operation 583: If i is equal to N, determine the i^{th} denoised intermediate motion feature as the denoised intermediate motion feature.

If i is equal to N, it indicates that denoising of the noise-added intermediate motion feature is completed, and an N^{th} denoised intermediate motion feature is the denoised intermediate motion feature obtained by denoising the noise-added intermediate motion feature through the at least two second denoisers sequentially.

In other words, if i is equal to 1, the noise-added intermediate motion feature is denoised for Tᵢ times through the first second denoiser, to obtain the first denoised intermediate motion feature. If i is greater than 1 and is less than N, an (i−1)^{th} denoised intermediate motion feature is denoised for Tᵢ times through an i^{th} second denoiser, to obtain an i^{th} denoised intermediate motion feature. If i is equal to N, an (N−1)^{th} denoised intermediate motion feature is denoised for Tᵢ times through an N^{th} second denoiser, to obtain an N^{th} denoised intermediate motion feature. The N^{th} denoised intermediate motion feature is the denoised intermediate motion feature.

For example, N is equal to 5. The noise-added intermediate motion feature is denoised for T₁ times through the first second denoiser, to obtain the first denoised intermediate motion feature. Then, the first denoised intermediate motion feature is denoised for T₂ times through the second second denoiser, to obtain the second denoised intermediate motion feature. Then, the second denoised intermediate motion feature is denoised for T₃ times through the third second denoiser, to obtain the third denoised intermediate motion feature. By analogy, the fourth denoised intermediate motion feature is denoised for Ts times through the fifth second denoiser, to obtain the fifth denoised intermediate motion feature. The fifth denoised intermediate motion feature is the denoised intermediate motion feature.

In this embodiment of this application, a plurality of second denoisers are arranged in the second diffusion model to denoise the noise-added intermediate motion feature, so that each second denoiser can be responsible for a denoising process within a specific time period, making the denoising process more detailed, thereby enhancing a detail feature in an output motion sequence and improving the richness of the details in the output motion sequence.

Operation 590: Decode the denoised intermediate motion feature through a second decoder, to obtain an output motion sequence matching the text.

The denoised intermediate motion feature is decoded through the second decoder, to reconstruct the denoised intermediate motion feature into the output motion sequence matching the text.

In the technical solution provided in the embodiments of this disclosure, the intermediate motion sequence is preliminarily generated in the feature space of the low dimension based on a denoising process of the first denoiser through the first diffusion model, and then based on matching the semantics of the text, the output motion sequence further matching the motion information of the text is generated in the feature space of the high dimension based on denoising processes of the at least two second denoisers through the second diffusion model. This enhances the detail feature in the output motion sequence and improves the richness of the details of the output motion sequence.

The motion generation model-based motion generation method provided in this application combines respective advantages of the first diffusion model in the feature space of the low dimension and the second diffusion model in the feature space of the high dimension, allowing the first diffusion model and the second diffusion model to be separately responsible for different stages of a reverse diffusion process, and finally generating a motion sequence that matches the text and has rich details of the motion information.

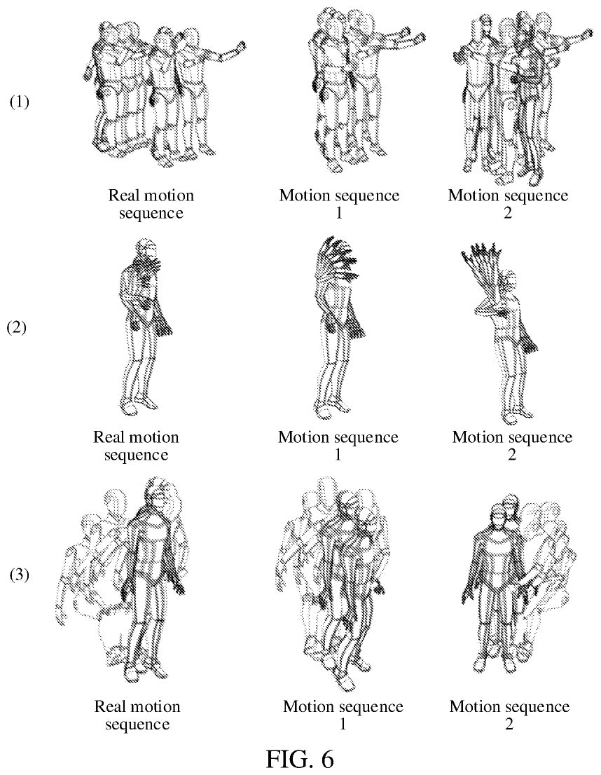

FIG. 6 is a schematic diagram of a plurality of different motion sequences that conform to text semantics. It can be seen from FIG. 6 that, according to the motion generation model-based motion generation method provided in the embodiments of this disclosure, for each text, a plurality of motion sequences that conform to the semantics of the text but have different detail features of motion information can be generated.

As shown in (1) in FIG. 6, both a motion sequence 1 and a motion sequence 2 are motion sequences generated based on the text “a person dancing with somebody”. Although there is a difference between the motion sequence 1 and a real motion sequence, the motion sequence 1 matches the semantics of the text. Therefore, both the motion sequence 1 and the motion sequence 2 can be used as motion sequences corresponding to the text “a person dancing with somebody”. The same reason applies to (2) and (3) in FIG. 6. A motion sequence 2 shown in (2) is different from a real motion sequence in (2), and a motion sequence 1 shown in (3) is different from a real motion sequence in (3). However, both a motion sequence 1 and the motion sequence 2 in (2) can be used as motion sequences corresponding to the text “a person waving the right hand”, and both the motion sequence 1 and a motion sequence 2 in (3) can be used as motion sequences corresponding to the text “a person stepping back and sitting on a chair with arms at both sides, and then standing up from the chair”.

As shown in FIG. 6, it can be seen that the technical solution provided in this application has a capability of generating diverse results while ensuring generation effects.

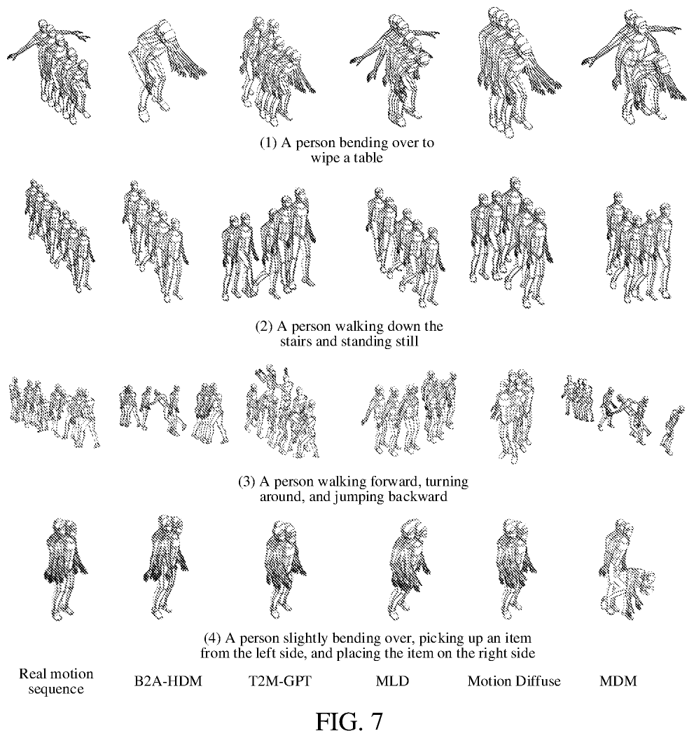

FIG. 7 is a schematic diagram of comparison between generation effects of the technical solution of this application and another motion sequence generation method.

It may be learned from the comparison that, the method provided in this application, namely, a fine-grained text-driven motion generation method based on a basic-to-advanced hierarchical diffusion model (B2A-HDM), is capable of better generating motion sequences that match the semantics of the text and have rich details. For example, it can be seen from (1), (2), (3), and (4) in FIG. 7 that Motion Diffuse and MDM fail to generate the motion sequences that match the semantics of the text, while T2M-GPT and MLD lack sufficient details in motion generation. The B2A-HDM provided in this application can simultaneously balance the matching degree between a generated result and the text, as well as the restoration degree of the motion details.

Table 1 below shows quantitative result comparison of the B2A-HDM provided in this application and another motion sequence generation method on a

TABLE 1

| | R-Precision | | | | MM- | | |
|---|---|---|---|---|---|---|---|
| Method | Top-1 | Top-2 | Top-3 | FID | Dist | Diversity | MModality |
| Real Motion | 0.511 | 0.703 | 0.797 | 0.002 | 2.974 | 9.503 | — |
| Seq2Seq | 0.180 | 0.300 | 0.396 | 11.75 | 5.529 | 6.223 | — |
| Language2Pose | 0.246 | 0.387 | 0.486 | 11.02 | 5.296 | 7.676 | — |
| Text2Gesture | 0.165 | 0.267 | 0.345 | 5.012 | 6.030 | 6.409 | — |
| Hier | 0.301 | 0.425 | 0.552 | 6.532 | 5.012 | 8.332 | — |
| MoCoGAN | 0.037 | 0.072 | 0.106 | 94.41 | 9.643 | 0.462 | 0.019 |
| Dance2Music | 0.033 | 0.065 | 0.097 | 66.98 | 8.116 | 0.725 | 0.043 |
| TM2T | 0.424 | 0.618 | 0.729 | 1.501 | 3.467 | 8.589 | 2.424 |
| T2M | 0.457 | 0.639 | 0.740 | 1.067 | 3.340 | 9.188 | 2.090 |
| MDM | 0.320 | 0.498 | 0.611 | 0.544 | 5.566 | 9.559 | 2.799 |
| Motion Diffuse | 0.491 | 0.681 | 0.782 | 0.630 | 3.113 | 9.410 | 1.553 |
| MLD | 0.481 | 0.673 | 0.772 | 0.473 | 3.196 | 9.724 | 2.413 |
| T2M-GPT | 0.491 | 0.680 | 0.775 | 0.116 | 3.118 | 9.761 | 1.856 |
| B2A-HDM | 0.511 | 0.699 | 0.791 | 0.084 | 3.020 | 9.526 | 1.914 |

Evaluation metrics for the comparison include R-Precision, FID, MM Dist, Diversity, and MModality. P-Precision and MM Dist are configured for measuring the matching degree between the generated result and the text; FID is configured for measuring the restoration degree of the generated result, that is, whether the generated result is close to a real sample; and Diversity and MModality are configured for measuring the diversity of the generated result.

Table 2 below shows quantitative result comparison of the B2A-HDM provided in this application and another motion sequence generation method on a KIT-ML dataset.

TABLE 2

| | R-Precision | | | | MM- | | |
|---|---|---|---|---|---|---|---|
| Method | Top-1 | Top-2 | Top-3 | FID | Dist | Diversity | MModality |
| Real Motion | 0.424 | 0.649 | 0.779 | 0.031 | 2.788 | 11.08 | — |
| Seq2Seq | 0.103 | 0.178 | 0.241 | 24.86 | 7.960 | 6.744 | — |
| Language2Pose | 0.221 | 0.373 | 0.483 | 6.545 | 5.147 | 9.073 | — |
| Text2Gesture | 0.156 | 0.255 | 0.338 | 12.12 | 6.964 | 9.334 | — |
| Hier | 0.255 | 0.432 | 0.531 | 5.203 | 4.986 | 9.563 | — |
| MOCOGAN | 0.022 | 0.042 | 0.063 | 82.69 | 10.47 | 3.091 | 0.250 |
| Dance2Music | 0.031 | 0.058 | 0.086 | 115.4 | 10.40 | 0.241 | 0.062 |
| TM2T | 0.280 | 0.463 | 0.587 | 3.599 | 4.591 | 9.473 | 3.292 |
| T2M | 0.361 | 0.559 | 0.681 | 3.022 | 3.488 | 10.72 | 2.052 |
| MDM | 0.164 | 0.291 | 0.396 | 0.497 | 9.191 | 10.85 | 1.907 |
| Motion Diffuse | 0.417 | 0.621 | 0.739 | 1.954 | 2.958 | 11.10 | 0.730 |
| MLD | 0.390 | 0.609 | 0.734 | 0.404 | 3.204 | 10.80 | 2.192 |
| T2M-GPT | 0.416 | 0.627 | 0.745 | 0.514 | 3.007 | 10.921 | 1.570 |
| B2A-HDM | 0.436 | 0.653 | 0.773 | 0.367 | 2.946 | 10.86 | 1.291 |

Both the comparison results of Table 1 and Table 2 above show that the B2A-HDM method provided in this application is significantly superior to the other motion sequence generation methods in terms of the metrics of the matching degree between the generated result and the text and the restoration degree of the generated result. In addition, in terms of the metrics of diversity, the B2A-HDM also achieves a good result, indicating that the B2A-HDM has a capability of generating diverse results.

FIG. 8 is a flowchart of a method for training a motion generation model according to an embodiment of this application. The motion generation model includes a text encoder, a first diffusion model, and a second diffusion model. Operations of the method may be performed by a computer device. The method may include at least one of the following operations 810 to 850.

Operation 810: Obtain a training sample set of the motion generation model, the training sample set including at least one motion text pair, each motion text pair including a sample text and an original motion sequence that have a matching relationship.

That the sample text and the original motion sequence have a matching relationship means that a motion described by the sample text matches a motion in the original motion sequence. That is, the motion described in the sample text is consistent with the motion in the original motion sequence. For example, if the motion described in the sample text is a shooting motion, at least one motion in the original motion sequence forms the shooting motion.

In some embodiments, one motion text pair includes one sample text and one original motion sequence, but the one sample text may correspond to a plurality of original motion sequences. Therefore, one motion text pair may be constructed based on each sample text and one of the original motion sequences, so that at least one motion text pair may be constructed for each sample text.

Operation 820: Generate a text feature of the sample text through the text encoder.

Operation 830: Generate, in a feature space of a first dimension based on the text feature through the first diffusion model, a first motion sequence matching the sample text.

In some embodiments, the first diffusion model includes a pre-trained first variational auto-encoder and a first denoiser. The first variational auto-encoder includes a first encoder and a first decoder.

In some embodiments, a first motion feature of first random noise is generated through the first encoder, a dimension of the first motion feature being the first dimension; and a first motion sequence matching the sample text is generated based on the first motion feature and the text feature through the first denoiser and the first decoder.

In some embodiments, first noise of the first dimension is added to the first motion feature, to obtain a noise-added first motion feature; the noise-added first motion feature is denoised based on the text feature through the first denoiser, to obtain a denoised first motion feature of the first dimension; and the denoised first motion feature is decoded through the first decoder, to obtain the first motion sequence matching the sample text.

For related content of the foregoing operation 820 and operation 830, refer to the foregoing embodiments, and details are not described herein again.

Operation 840: Generate, in a feature space of a second dimension based on the text feature through the second diffusion model, a second motion sequence matching the sample text, the second dimension being greater than the first dimension.

In some embodiments, the second diffusion model includes a pre-trained second variational auto-encoder and at least two second denoisers. The second variational auto-encoder includes a second encoder and a second decoder.

In some embodiments, a second motion feature of second random noise is generated through the second encoder, a dimension of the second motion feature being the second dimension; and a second motion sequence matching the sample text is generated based on the second motion feature and the text feature through the at least two second denoisers and the second decoder.

In some embodiments, second noise of the second dimension is added to the second motion feature, to obtain a noise-added second motion feature; the noise-added second motion feature is denoised based on the text feature through the at least two second denoisers sequentially, to obtain a denoised second motion feature of the second dimension; and the denoised second motion feature is decoded through the second decoder, to obtain the second motion sequence matching the sample text.

In some embodiments, a quantity of second denoisers is N, and N is an integer greater than or equal to 2. The noise-added second motion feature is denoised for Tᵢ times based on the text feature through an i^{th} second denoiser, to obtain an i^{th} denoised second motion feature, i being a positive integer less than or equal to N, an initial value of i being 1, and Tᵢ being a positive integer.

In some embodiments, if i is less than N, i is incremented by 1, and the operation of denoising the noise-added second motion feature for Tᵢ times through an i^{th} second denoiser, to obtain an i^{th} denoised second motion feature is repeated; or if i is equal to N, the i^{th} denoised second motion feature is determined as the denoised second motion feature.

For related content of the foregoing operation 840, refer to the foregoing embodiments corresponding to operation 830, and details are not described herein again.

In this embodiment of this application, a method for training the second diffusion model is the same as a method for training the first diffusion model, in which a motion feature of random noise is trained based on the motion text pair in the training sample set. A difference is that the first diffusion model is a modeling and diffusion process in the feature space of the first dimension, while the second diffusion model is a modeling and diffusion process in the feature space of the second dimension.

Operation 850: Adjust parameters of the first diffusion model based on the first motion sequence and the original motion sequence, and adjust parameters of the second diffusion model based on the second motion sequence and the original motion sequence, to obtain a trained motion generation model.

In the method for training a motion generation model, the first diffusion model and the second diffusion model are separately trained. In other words, the first diffusion model and the second diffusion model are separately trained as independent diffusion models. When a motion sequence is generated based on the motion generation model, output data of the first diffusion model is used as input data of the second diffusion model, to associate the two models.

Therefore, the parameters of the first diffusion model and the second diffusion model need to be separately adjusted in operation 850. After the adjustment is completed, the trained motion generation model may be obtained.

Since the first variational auto-encoder and the second variational auto-encoder are pre-trained auto-encoders, the adjustment of the parameters of the first diffusion model and the second diffusion model may be transformed to adjustment of parameters of the first denoiser and the at least two second denoisers, and further, may be transformed to the adjustment of the parameters of the first denoiser and the at least two second denoisers based on noise respectively added to the first variational auto-encoder and the second variational auto-encoder and noise in a motion sample pair.

Exemplarily, a process of training the first diffusion model is used as an example for description. For a process of training the second diffusion model, refer to the process of training the first diffusion model.

The first denoiser is responsible for modeling a reverse diffusion process in the feature space of the first dimension, to be specific, gradually restoring a motion feature in the feature space of the first dimension from Gaussian noise through a plurality of rounds of iterations. To train the first denoiser, it is necessary to gradually add noise to the first motion feature through a forward diffusion process to obtain input data of the first denoiser. A process of gradual noise addition conforms to a Markov chain property, and may be expressed by the following mathematical formula.

$$q ( {z}_{1 : T} \vert {z}_{0} ) = {\prod }_{1}^{T} q ( {z}_{t} \vert {z}_{t - 1} ) .$$

$$q ( {z}_{t} \vert {z}_{t - 1} ) = 𝒩 ( {z}_{t} ; \sqrt{1 - {β}_{t}} {z}_{t - 1} , {β}_{t} I ) .$$

T represents a total quantity of times of noise addition in the forward diffusion process of the first diffusion model. zₜ represents a first motion feature obtained through t times of noise addition. βₜ is a noise weight hyperparameter related to a quantity of times of noise addition t. A value range of βₜ is (0, 1). I represents an all-ones vector or a unit matrix. A presentation form of I is associated with a presentation form of added noise. [symbol] represents that the added noise is noise satisfying a Gaussian distribution. q(zₜ|zₜ₋₁) represents a probability of obtaining the first motion feature zₜ through t times of noise addition base on a first motion feature zₜ₋₁ obtained through t−1 times of noise addition.

By using a reparameterization trick, noise zₜ added in any time t of noise addition may be sampled in a simpler representation form.

$${z}_{t} = \sqrt{{\overline{α}}_{t}} {z}_{0} + {ϵ}_{t} \sqrt{1 - {\overline{α}}_{t}} , {ϵ}_{t} ∼ 𝒩 ( 0 , I ) .$$

$${\overline{α}}_{t} = {\prod }_{s = 1}^{t} {α}_{s} ,$$

αₛ=1−βₛ, and ϵₜ represents noise that satisfies the Gaussian distribution and is added in a t^{th} time of noise addition.

Operation 850 includes at least one sub-operation of operations 851 to 853 (not shown in FIG. 8).

Operation 851: Determine predicted noise of the original motion sequence based on the original motion sequence.

The predicted noise refers to noise that is predicted based on the original motion sequence and that is to be added in a diffusion process in which the original motion sequence is obtained based on the sample text.

Operation 852: Calculate a first loss function value based on the first noise and the predicted noise, and calculate a second loss function value based on the second noise and the predicted noise.

The first loss function value represents a difference between the first noise and the predicted noise, and the second loss function value represents a difference between the second noise and the predicted noise.

Exemplarily, the first loss function value may be calculated based on the first noise and the predicted noise by using a mean squared error (MSE) loss algorithm. The first loss function value may be represented as the following formula.

$${ℒ}^{ϵ} = {𝔼}_{ϵ ∼ 𝒩 ( 0 , I ) , t ∈ [ 1 , T ]} [ ‖ ϵ - {ϵ}_{θ}^{l} ( {z}_{t} , {τ}_{θ} ( w ) , t ) ‖ ] .$$

ϵ represents the first noise,

$${ϵ}_{θ}^{l} ( {z}_{t} , {τ}_{θ} ( w ) , t )$$

represents the predicted noise, and τ_{θ}(w) represents the text feature obtained by encoding the sample text by the text encoder. [symbol] represents the first loss function value.

In addition, to enable a modeling and diffusion process of the first diffusion model in a feature space of a higher dimension as much as possible, the calculation of the first loss function value is improved, so that a penalty for a model prediction error in an early stage of denoising (when t is larger) is larger, and a penalty for a prediction error in a later stage of denoising (when t is smaller) is smaller. This may be specifically represented as:

$${ℒ}_{t}^{ϵ} = λ ( t ) {ℒ}^{ϵ} , λ ( t ) = ( 1 - {\overline{α}}_{t} ) * {w}_{1} + {w}_{2} .$$

w₁ and w₂ are weight hyperparameters. w₁ and w₂ are positive numbers configured for constraining a value range of the first loss function value

$${ℒ}_{t}^{ϵ}$$

within a threshold range. Exemplarily, if the value range may be constrained between 0.5 and 5, w₁ and w₂ may be respectively set to 4.5 and 0.5.

A manner of calculating the second loss function value is similar to a manner of calculating the first loss function value, and is not described herein again.

Operation 853: Adjust parameters of the first denoiser based on the first loss function value to obtain a trained first diffusion model, and adjust parameters of the at least two second denoisers based on the second loss function value to obtain a trained second diffusion model.

Exemplarily, a training process of the first diffusion model is used as an example. The parameters of the first denoiser are adjusted based on the first loss function value

$${ℒ}_{t}^{ϵ} ,$$

to obtain the trained first diffusion model. In addition, the parameters of the at least two second denoisers are adjusted based on the second loss function value, to obtain the trained second diffusion model, to obtain the trained motion generation model.

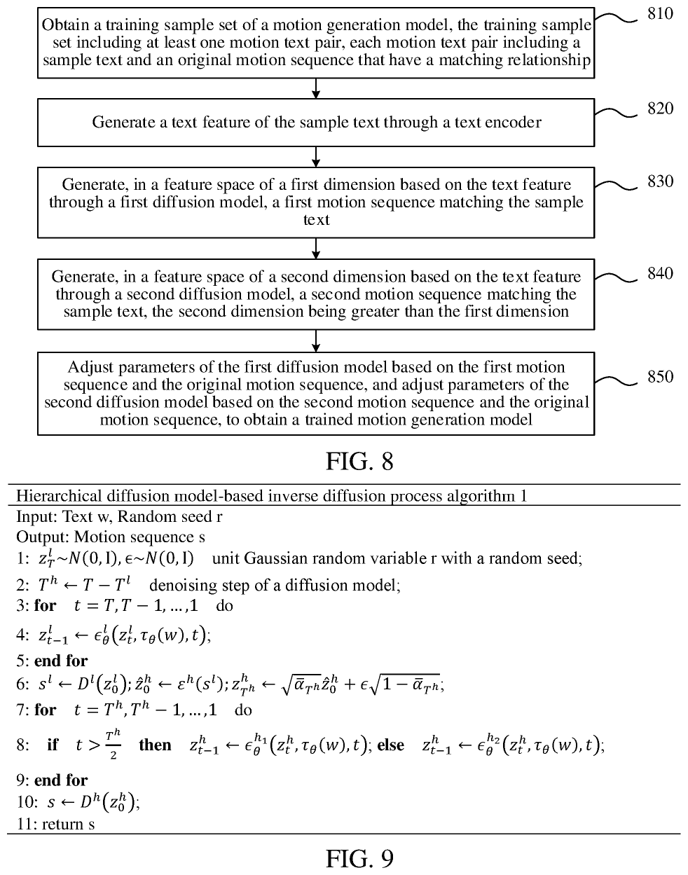

FIG. 9 is an algorithm flowchart of a use process of a motion generation model. A first denoiser

$${ϵ}_{θ}^{l}$$

of a first diffusion model is first used, to perform a complete T-step reverse diffusion process in a feature space of a first dimension based on a text w, to obtain a motion feature

$${z}_{0}^{l}$$

in the feature space of the first dimension. Next, a first decoder [symbol] of the first diffusion model restores the motion feature

$${z}_{0}^{l}$$

into a motion sequence s^{l}. The motion sequence s^{l} is the intermediate motion sequence in the foregoing embodiments.

The motion sequence s^{l} outputted by the first diffusion model is used as input data of a second diffusion model. A second encoder ε^{h} of the second diffusion model is used, to map the motion sequence s^{l} generated by the first diffusion model to a feature space of a second dimension, and perform a T^{h}-step forward diffusion and noise addition process, to obtain a noise-added motion feature

$${z}_{{T}^{h}}^{h} .$$

Then, denoisers

$${ϵ}_{θ}^{{h}_{1}} and {ϵ}_{θ}^{{h}_{2}}$$

of the second diffusion model are used to sequentially complete the rest reverse diffusion and denoising process, to obtain a motion feature

$${z}_{0}^{h}$$

in the feature space of the second dimension. Finally, a second decoder [symbol] of the second diffusion model is used again, to restore the motion feature

$${z}_{0}^{h}$$

into a motion sequence s. The motion sequence s is the output motion sequence in the foregoing embodiments.

In the technical solution provided in the embodiments of this disclosure, the first diffusion model and the second diffusion model are separately trained, so that both the first diffusion model and the second diffusion model can achieve a good training effect. In this way, diffusion models of different dimensions can be matched, to obtain a multi-level diffusion model, to generate the motion sequence matching the sample text. In addition, this can avoid a problem that the parameters of the second diffusion model cannot be significantly adjusted during joint training, limiting the use of the second diffusion model and making it only usable as the second diffusion model in the training model.

The following is an apparatus embodiment of this application, which can be used to perform the method embodiments of this disclosure. For details not disclosed in the apparatus embodiment of this application, refer to the method embodiments of this disclosure.

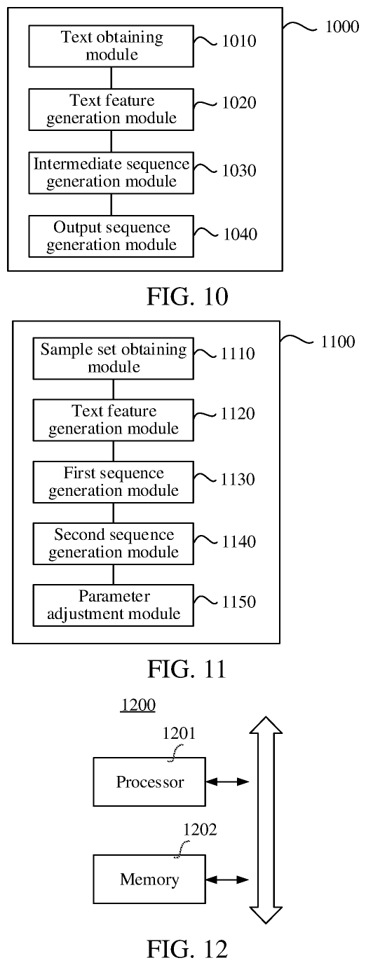

FIG. 10 is a block diagram of a motion generation model-based motion generation apparatus according to an embodiment of this application. The motion generation model includes a text encoder, a first diffusion model, and a second diffusion model. The apparatus has a function of implementing the foregoing motion generation model-based motion generation method. The function may be implemented by hardware, or may be implemented by hardware executing corresponding software. The apparatus may be the computer device described above, or may be disposed in the computer device. As shown in FIG. 10, the apparatus 1000 may include: a text obtaining module 1010, a text feature generation module 1020, an intermediate sequence generation module 1030, and an output sequence generation module 1040.

The text obtaining module 1010 is configured to obtain a text containing motion information.

The text feature generation module 1020 is configured to generate a text feature of the text through the text encoder.

The intermediate sequence generation module 1030 is configured to generate an intermediate motion sequence in a feature space of a first dimension based on the text feature through the first diffusion model.

The output sequence generation module 1040 is configured to perform detail enhancement processing on the intermediate motion sequence in a feature space of a second dimension through the second diffusion model, to obtain an output motion sequence matching the text, the second dimension being greater than the first dimension.

In some embodiments, the first diffusion model includes a first variational auto-encoder and a first denoiser. The first variational auto-encoder includes a first encoder and a first decoder. The intermediate sequence generation module 1030 includes a random feature generation unit and an intermediate sequence generation unit.

The random feature generation unit is configured to generate a random motion feature of random noise through the first encoder, a dimension of the random motion feature being the first dimension.

The intermediate sequence generation unit is configured to generate the intermediate motion sequence based on the random motion feature and the text feature through the first denoiser and the first decoder.

In some embodiments, the intermediate sequence generation unit is configured to: add first noise of the first dimension to the random motion feature, to obtain a noise-added random motion feature; denoise the noise-added random motion feature based on the text feature through the first denoiser, to obtain a denoised random motion feature of the first dimension; and decode the denoised random motion feature through the first decoder, to obtain the intermediate motion sequence.

In some embodiments, the second diffusion model includes a second variational auto-encoder and at least two second denoisers. The second variational auto-encoder includes a second encoder and a second decoder. The output sequence generation module 1040 includes an intermediate feature generation unit and an output sequence generation unit.

The intermediate feature generation unit is configured to generate an intermediate motion feature of the intermediate motion sequence through the second encoder, a dimension of the intermediate motion feature being the second dimension.

The output sequence generation unit is configured to generate, based on the intermediate motion feature through the at least two second denoisers and the second decoder, the output motion sequence matching the text.

In some embodiments, the output sequence generation unit is configured to: add second noise of the second dimension to the intermediate motion feature, to obtain a noise-added intermediate motion feature; denoise the noise-added intermediate motion feature through the at least two second denoisers sequentially, to obtain a denoised intermediate motion feature of the second dimension; and decode the denoised intermediate motion feature through the second decoder, to obtain the output motion sequence matching the text.

In some embodiments, a quantity of second denoisers is N, and N is an integer greater than or equal to 2. The output sequence generation unit is configured to: denoise the noise-added intermediate motion feature for Tᵢ times through an i^{th} second denoiser, to obtain an i^{th} denoised intermediate motion feature, i being a positive integer less than or equal to N, an initial value of i being 1, and Tᵢ being a positive integer; and if i is less than N, increment i by 1, and repeat the operation of denoising the noise-added intermediate motion feature for Tᵢ times through an i^{th} second denoiser, to obtain an i^{th} denoised intermediate motion feature; or if i is equal to N, determine the i^{th} denoised intermediate motion feature as the denoised intermediate motion feature.

In the technical solution provided in the embodiments of this disclosure, the first diffusion model can process a feature in the feature space of the first dimension, the second diffusion model can process a feature in the feature space of the second dimension, and the second dimension is greater than the first dimension, so that the second diffusion model can focus more on a fine-grained feature. Therefore, the intermediate motion sequence is generated in the feature space of the first dimension through the first diffusion model, and modeling and diffusion is preliminarily performed on the text in the feature space of a low dimension. Since the motion sequence obtained through diffusion in the feature space of the low dimension lacks rich details, detail enhancement processing is further performed on the intermediate motion sequence in the feature space of the second dimension through the second diffusion model, to obtain an output motion sequence. Since the motion sequence is refined in the feature space of a high dimension, the output motion sequence has richer details and more closely matches the text. Compared with the related art in which a text modeling and diffusion process is performed only in the feature space of the low dimension, resulting in insufficient details of the generated motion sequence, the technical solution provided in this application enhances a detail feature in the output motion sequence in the feature space of the high dimension, thereby improving the richness of details in the output motion sequence.

FIG. 11 is a block diagram of an apparatus for training a motion generation model according to an embodiment of this application. The motion generation model includes a text encoder, a first diffusion model, and a second diffusion model. The apparatus has a function of implementing the foregoing motion generation model-based motion generation method. The function may be implemented by hardware, or may be implemented by hardware executing corresponding software. The apparatus may be the computer device described above, or may be disposed in the computer device. As shown in FIG. 11, the apparatus 1100 may include: a sample set obtaining module 1110, a text feature generation module 1120, a first sequence generation module 1130, a second sequence generation module 1140, and a parameter adjustment module 1150.

The sample set obtaining module 1110 is configured to obtain a training sample set of the motion generation model, the training sample set including at least one motion text pair, each motion text pair including a sample text and an original motion sequence that have a matching relationship.

The text feature generation module 1120 is configured to generate a text feature of the sample text through the text encoder.

The first sequence generation module 1130 is configured to generate, in a feature space of a first dimension based on the text feature through the first diffusion model, a first motion sequence matching the sample text.

The second sequence generation module 1140 is configured to generate, in a feature space of a second dimension based on the text feature through the second diffusion model, a second motion sequence matching the sample text, the second dimension being greater than the first dimension.

The parameter adjustment module 1150 is configured to: adjust parameters of the first diffusion model based on the first motion sequence and the original motion sequence, and adjust parameters of the second diffusion model based on the second motion sequence and the original motion sequence, to obtain a trained motion generation model.

In some embodiments, the first diffusion model includes a pre-trained first variational auto-encoder and a first denoiser. The first variational auto-encoder includes a first encoder and a first decoder. The first sequence generation module 1130 includes a first feature generation unit and a first sequence generation unit.

The first feature generation unit is configured to generate a first motion feature of first random noise through the first encoder, a dimension of the first motion feature being the first dimension.

The first sequence generation unit is configured to generate, based on the first motion feature and the text feature through the first denoiser and the first decoder, the first motion sequence matching the sample text.

In some embodiments, the first sequence generation unit is configured to: add first noise of the first dimension to the first motion feature, to obtain a noise-added first motion feature; denoise the noise-added first motion feature based on the text feature through the first denoiser, to obtain a denoised first motion feature of the first dimension; and decode the denoised first motion feature through the first decoder, to obtain the first motion sequence matching the sample text.

In some embodiments, the second diffusion model includes a pre-trained second variational auto-encoder and at least two second denoisers. The second variational auto-encoder includes a second encoder and a second decoder. The second sequence generation module 1140 includes a second feature generation unit and a second sequence generation unit.

The second feature generation unit is configured to generate a second motion feature of second random noise through the second encoder, a dimension of the second motion feature being the second dimension.

The second sequence generation unit is configured to generate, based on the second motion feature and the text feature through the at least two second denoisers and the second decoder, the second motion sequence matching the sample text.

In some embodiments, the second sequence generation unit is configured to: add second noise of the second dimension to the second motion feature, to obtain a noise-added second motion feature; denoise the noise-added second motion feature based on the text feature through the at least two second denoisers sequentially, to obtain a denoised second motion feature of the second dimension; and decode the denoised second motion feature through the second decoder, to obtain the second motion sequence matching the sample text.

In some embodiments, a quantity of second denoisers is N, and N is an integer greater than or equal to 2. The second sequence generation unit is configured to: denoise the noise-added second motion feature for Tᵢ times through an i^{th} second denoiser, to obtain an i^{th} denoised second motion feature, i being a positive integer less than or equal to N, an initial value of i being 1, and Tᵢ being a positive integer; and if i is less than N, increment i by 1, and repeat the operation of denoising the noise-added second motion feature for Tᵢ times through an i^{th} second denoiser, to obtain an i^{th} denoised second motion feature; or if i is equal to N, determine the i^{th} denoised second motion feature as the denoised second motion feature.

In some embodiments, the parameter adjustment module 1150 is configured to: determine predicted noise of the original motion sequence based on the original motion sequence; calculate a first loss function value based on the first noise and the predicted noise, and calculate a second loss function value based on the second noise and the predicted noise; and adjust parameters of the first denoiser based on the first loss function value to obtain a trained first diffusion model, and adjust parameters of the at least two second denoisers based on the second loss function value to obtain a trained second diffusion model.

In the technical solution provided in the embodiments of this disclosure, the first diffusion model and the second diffusion model are separately trained, so that both the first diffusion model and the second diffusion model can achieve a good training effect. In this way, diffusion models of different dimensions can be matched, to obtain a multi-level diffusion model, to generate the motion sequence matching the sample text. In addition, this can avoid a problem that the parameters of the second diffusion model cannot be significantly adjusted during joint training, limiting the use of the second diffusion model and making it only usable as the second diffusion model in the training model.

When the apparatus provided in the foregoing embodiments implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method embodiments provided in the foregoing embodiments belong to the same conception. For the specific implementation process, refer to the method embodiments, and details are not described herein again.

FIG. 12 is a structural block diagram of a computer device 1200 according to an embodiment of this application. The computer device 1200 may be any electronic device having data calculation, processing, and storage functions. The computer device 1200 may be configured to implement the motion generation model-based motion generation method or the method for training a motion generation model provided in the foregoing embodiments.

Generally, the computer device 1200 includes a processor 1201 and a memory 1202.

The processor 1201 may include one or more processing cores, and may be, for example, a 4-core processor or an 8-core processor. The processor 1201 may be implemented by using at least one hardware form of a digital signal processor (DSP), a field programmable gate array (FPGA), and a programmable logic array (PLA). The processor 1201 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1201 may be integrated with a graphics processing unit (GPU). The GPU is configured to be responsible for rendering and drawing content that a display needs to display. In some embodiments, the processor 1201 may further include an AI processor. The AI processor is configured to process a computing operation related to machine learning.

The memory 1202 may include one or more computer-readable storage media that may include non-transitory. The memory 1202 may further include a high-speed random access memory and a non-volatile memory, for example, one or more disk storage devices or flash storage devices. In some embodiments, the non-transitory computer-readable storage medium in the memory 1202 is configured to store a computer program, the computer program being configured to be executed by one or more processors to implement the foregoing motion generation model-based motion generation method or the method for training a motion generation model.

A person skilled in the art may understand that the structure shown in FIG. 12 does not constitute any limitation on the computer device 1200, and the computer device may include more components or fewer components than those shown in the figure, or some components may be combined, or a different component deployment may be used.

In an exemplary embodiment, a computer-readable storage medium (e.g., non transitory computer-readable storage medium) is further provided, having a computer program stored therein, the computer program, when executed by a processor of a computer device, implementing the foregoing motion generation model-based motion generation method or the method for training a motion generation model Optionally, the computer-readable storage medium may be a read-only memory (ROM), a random access memory (RAM), a compact disc read-only memory (CD-ROM), a magnetic tape, a floppy disk, an optical data storage device, or the like.

In an example embodiment of this application, a computer program product is provided. The computer program product includes a computer program, and the computer program is stored in a computer-readable storage medium (e.g., non transitory computer-readable storage medium). A processor of a computer device reads the computer program from the computer-readable storage medium, and the processor executes the computer program, causing the computer device to perform the foregoing motion generation model-based motion generation method, or the method for training a motion generation model.

In this application, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently collected. In this way, in this application, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data collected in this application is strictly processed according to requirements of relevant national laws and regulations. The obtained personal information is collected with consent and authorization of the user within the scope of authorization of the laws and regulations and a subject of the personal information. Performing of subsequent data use and processing, and collection, use, and processing of the relevant user data are required to comply with relevant laws, regulations, and standards of relevant countries and regions.

It is to be understood that “plurality of” mentioned in this specification means two or more. And/or describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, the step numbers described in this specification merely schematically show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this disclosure.

The foregoing descriptions are merely exemplary embodiments of this disclosure, but are not intended to limit this application. Any modification, equivalent replacement, or improvement made within the spirit and principle of this application shall fall within the protection scope of this application.

What is claimed is:

1. A motion generation method, performed by a computer device using a motion generation model, the motion generation model comprising a text encoder, a first diffusion model, and a second diffusion model, and the method comprising:
obtaining a text comprising motion information;
generating a text feature corresponding to the text via the text encoder;
generating an intermediate motion sequence in a feature space of a first dimension based on the text feature via the first diffusion model; and
performing detail enhancement processing on the intermediate motion sequence in a feature space of a second dimension through the second diffusion model, to obtain an output motion sequence matching the text, the second dimension being greater than the first dimension.

2. The method according to claim 1, wherein:
the first diffusion model comprises a first variational auto-encoder and a first denoiser, the first variational auto-encoder comprises a first encoder and a first decoder; and
generating the intermediate motion sequence comprises:
generating a random motion feature of random noise via the first encoder, a dimension of the random motion feature being the first dimension; and
generating the intermediate motion sequence based on the random motion feature and the text feature via the first denoiser and the first decoder.

3. The method according to claim 2, wherein generating the intermediate motion sequence comprises:
adding first noise of the first dimension to the random motion feature, to obtain a noise-added random motion feature;
denoising the noise-added random motion feature based on the text feature via the first denoiser, to obtain a denoised random motion feature of the first dimension; and
decoding the denoised random motion feature via the first decoder, to obtain the intermediate motion sequence.

4. The method according to claim 1, wherein:
the second diffusion model comprises a second variational auto-encoder and at least two second denoisers, and the second variational auto-encoder comprises a second encoder and a second decoder; and
performing the detail enhancement processing on the intermediate motion sequence in the feature space of the second dimension via the second diffusion model, to obtain the output motion sequence matching the text comprises:
generating an intermediate motion feature of the intermediate motion sequence via the second encoder, a dimension of the intermediate motion feature being the second dimension; and
generating, based on the intermediate motion feature via the at least two second denoisers and the second decoder, the output motion sequence matching the text.

5. The method according to claim 4, wherein generating the output motion sequence matching the text comprises:
adding second noise of the second dimension to the intermediate motion feature, to obtain a noise-added intermediate motion feature;
denoising the noise-added intermediate motion feature via the at least two second denoisers sequentially, to obtain a denoised intermediate motion feature of the second dimension; and
decoding the denoised intermediate motion feature via the second decoder, to obtain the output motion sequence matching the text.

6. The method according to claim 5, wherein:
a quantity of the second denoisers is N, and N is an integer greater than or equal to 2; and
denoising the noise-added intermediate motion feature via the at least two second denoisers sequentially, to obtain the denoised intermediate motion feature of the second dimension comprises:
denoising the noise-added intermediate motion feature for Tᵢ times via an i^{th} second denoiser, to obtain an i^{th} denoised intermediate motion feature, i being a positive integer less than or equal to N, an initial value of i being 1, and Tᵢ being a positive integer;
when i is less than N, incrementing i by 1, and repeating the operation of denoising the noise-added intermediate motion feature for Tᵢ times through an i^{th} second denoiser, to obtain an i^{th} denoised intermediate motion feature; and
when i is equal to N, determining the i^{th} denoised intermediate motion feature as the denoised intermediate motion feature.

7. A method for training a motion generation model, performed by a computer device, the motion generation model comprising a text encoder, a first diffusion model, and a second diffusion model, and the method comprising:
obtaining a training sample set for the motion generation model, the training sample set comprising at least one motion text pair, each motion text pair comprising a sample text and an original motion sequence that have a matching relationship;
generating a text feature of the sample text via the text encoder;
generating, via the first diffusion model in a feature space of a first dimension, a first motion sequence matching the sample text based on the text feature;
generating, via the second diffusion model in a feature space of a second dimension, a second motion sequence matching the sample text based on the text feature, the second dimension being greater than the first dimension; and
adjusting parameters of the first diffusion model based on the first motion sequence and the original motion sequence, and adjusting parameters of the second diffusion model based on the second motion sequence and the original motion sequence, to obtain the motion generation model.

8. The method according to claim 7, wherein:
the first diffusion model comprises a pre-trained first variational auto-encoder and a first denoiser, the first variational auto-encoder comprises a first encoder and a first decoder; and
generating the first motion sequence matching the sample text comprises:
generating a first motion feature of first random noise through the first encoder, a dimension of the first motion feature being the first dimension; and
generating, based on the first motion feature and the text feature via the first denoiser and the first decoder, the first motion sequence matching the sample text.

9. The method according to claim 8, wherein generating the first motion sequence matching the sample text comprises:
adding first noise of the first dimension to the first motion feature, to obtain a noise-added first motion feature;
denoising the noise-added first motion feature based on the text feature through the first denoiser, to obtain a denoised first motion feature of the first dimension; and
decoding the denoised first motion feature through the first decoder, to obtain the first motion sequence matching the sample text.

10. The method according to claim 9, wherein:
the second diffusion model comprises a pre-trained second variational auto-encoder and at least two second denoisers, and the second variational auto-encoder comprises a second encoder and a second decoder; and
generating the second motion sequence matching the sample text comprises:
generating a second motion feature of second random noise via the second encoder, a dimension of the second motion feature being the second dimension; and
generating, based on the second motion feature and the text via through the at least two second denoisers and the second decoder, the second motion sequence matching the sample text.

11. The method according to claim 10, wherein generating the second motion sequence matching the sample text comprises:
adding second noise of the second dimension to the second motion feature, to obtain a noise-added second motion feature;
denoising the noise-added second motion feature based on the text feature via the at least two second denoisers sequentially, to obtain a denoised second motion feature of the second dimension; and
decoding the denoised second motion feature via the second decoder, to obtain the second motion sequence matching the sample text.

12. The method according to claim 11, wherein:
a quantity of second denoisers is N, and N is an integer greater than or equal to 2; and
denoising the noise-added second motion feature based on the text feature via the at least two second denoisers sequentially, to obtain the denoised second motion feature of the second dimension comprises:
denoising the noise-added second motion feature for Tᵢ times based on the text feature through an i^{th} second denoiser, to obtain an i^{th} denoised second motion feature, i being a positive integer less than or equal to N, an initial value of i being 1, and Tᵢ being a positive integer;
when i is less than N, incrementing i by 1, and repeating the operation of denoising the noise-added second motion feature for Tᵢ times through an i^{th} second denoiser, to obtain an i^{th} denoised second motion feature; and
when i is equal to N, determining the i^{th} denoised second motion feature as the denoised second motion feature.

13. The method according to claim 10, wherein adjusting parameters of the first diffusion model based on the first motion sequence and the original motion sequence, and adjusting parameters of the second diffusion model based on the second motion sequence and the original motion sequence, to obtain the motion generation model comprises:
determining predicted noise of the original motion sequence based on the original motion sequence;
calculating a first loss function value based on the first noise and the predicted noise, and calculating a second loss function value based on the second noise and the predicted noise; and
adjusting parameters of the first denoiser based on the first loss function value to obtain a trained first diffusion model, and adjusting parameters of the at least two second denoisers based on the second loss function value to obtain a trained second diffusion model.

14. A device for training a motion generation model, performed by a computer device, the motion generation model comprising a text encoder, a first diffusion model, and a second diffusion model, the device comprising a memory for storing computer instructions and a processor in communication with the memory, wherein, when the processor executes the computer instructions, the processor is configured to cause the device to:
obtain a training sample set for the motion generation model, the training sample set comprising at least one motion text pair, each motion text pair comprising a sample text and an original motion sequence that have a matching relationship;
generate a text feature of the sample text via the text encoder;
generate, via the first diffusion model in a feature space of a first dimension, a first motion sequence matching the sample text based on the text feature;
generate, via the second diffusion model in a feature space of a second dimension, a second motion sequence matching the sample text based on the text feature, the second dimension being greater than the first dimension; and
adjust parameters of the first diffusion model based on the first motion sequence and the original motion sequence, and adjusting parameters of the second diffusion model based on the second motion sequence and the original motion sequence, to obtain the motion generation model.

15. The device according to claim 14, wherein:
the first diffusion model comprises a pre-trained first variational auto-encoder and a first denoiser, the first variational auto-encoder comprises a first encoder and a first decoder; and
when the processor is configured to cause the device to generate the first motion sequence matching the sample text, the processor is configured to cause the device to:
generate a first motion feature of first random noise through the first encoder, a dimension of the first motion feature being the first dimension; and
generate, based on the first motion feature and the text feature via the first denoiser and the first decoder, the first motion sequence matching the sample text.

16. The device according to claim 15, wherein, when the processor is configured to cause the device to generate the first motion sequence matching the sample text, the processor is configured to cause the device to:
add first noise of the first dimension to the first motion feature, to obtain a noise-added first motion feature;
denoise the noise-added first motion feature based on the text feature through the first denoiser, to obtain a denoised first motion feature of the first dimension; and
decode the denoised first motion feature through the first decoder, to obtain the first motion sequence matching the sample text.

17. The device according to claim 16, wherein:
the second diffusion model comprises a pre-trained second variational auto-encoder and at least two second denoisers, and the second variational auto-encoder comprises a second encoder and a second decoder; and
when the processor is configured to cause the device to generate the second motion sequence matching the sample text, the processor is configured to cause the device to:
generate a second motion feature of second random noise via the second encoder, a dimension of the second motion feature being the second dimension; and
generate, based on the second motion feature and the text via through the at least two second denoisers and the second decoder, the second motion sequence matching the sample text.

18. The device according to claim 17, wherein, when the processor is configured to cause the device to generate the second motion sequence matching the sample text, the processor is configured to cause the device to:
add second noise of the second dimension to the second motion feature, to obtain a noise-added second motion feature;
denoise the noise-added second motion feature based on the text feature via the at least two second denoisers sequentially, to obtain a denoised second motion feature of the second dimension; and
decode the denoised second motion feature via the second decoder, to obtain the second motion sequence matching the sample text.

19. The device according to claim 18, wherein:
a quantity of second denoisers is N, and N is an integer greater than or equal to 2; and
when the processor is configured to cause the device to denoise the noise-added second motion feature based on the text feature via the at least two second denoisers sequentially, to obtain the denoised second motion feature of the second dimension, the processor is configured to cause the device to:
denoise the noise-added second motion feature for Tᵢ times based on the text feature through an i^{th} second denoiser, to obtain an i^{th} denoised second motion feature, i being a positive integer less than or equal to N, an initial value of i being 1, and Tᵢ being a positive integer;
when i is less than N, incrementing i by 1, and repeating the operation of denoising the noise-added second motion feature for Tᵢ times through an i^{th} second denoiser, to obtain an i^{th} denoised second motion feature; and
when i is equal to N, determining the i^{th} denoised second motion feature as the denoised second motion feature.

20. The device according to claim 17, wherein, when the processor is configured to cause the device to adjust parameters of the first diffusion model based on the first motion sequence and the original motion sequence, and adjust parameters of the second diffusion model based on the second motion sequence and the original motion sequence, to obtain the motion generation model, the processor is configured to cause the device to:
determine predicted noise of the original motion sequence based on the original motion sequence;
calculate a first loss function value based on the first noise and the predicted noise, and calculating a second loss function value based on the second noise and the predicted noise; and
adjust parameters of the first denoiser based on the first loss function value to obtain a trained first diffusion model, and adjusting parameters of the at least two second denoisers based on the second loss function value to obtain a trained second diffusion model.
